(19) United States
(12) Patent Application Publication
(10) Pub. No.: US 2007/0253198 A1
(43) Pub. Date: Nov. 1, 2007

(54) STREET LIGHT

(76) Inventor: Steven John Pelegrin, Grain Valley, MO (US)

Correspondence Address: LATHROP & GAGE LC, 2345 GRAND AVENUE, SUITE 2800, KANSAS CITY, MO, 64108, US

(21) Appl. No.: 11/741,404

(22) Filed: Apr. 27, 2007

Related U.S. Application Data
(60) Provisional application No. 60/746,031, filed on Apr. 29, 2006.

(51) Int. Cl. F21V 5/00

(52) U.S. Cl. 362/246; 362/249; 362/240

(57) ABSTRACT

A system and method for illuminating is disclosed. The disclosed invention is fittable and usable in many conventional street lighting structures. The system includes a circuit board which includes a plurality of LEDs. Each end of the circuit board is insertable into a receiving structural member on each side. Each of the structural members are installable on an existing lens in the predisposed structure. Also included with the system is an Edison connector which electrically communicates with the circuit board so that the LEDs can be illuminated.

### CROSS-REFERENCE TO RELATED APPLICATIONS

This application claims the benefit of U.S. Provisional Patent Application No. 60/746,031 filed Apr. 29, 2006 under the name of the same inventor, the entire contents of which are herein incorporated by reference.

### BACKGROUND OF THE INVENTION

1. Field of the Invention

The invention relates generally to systems for illumination. More specifically, the invention relates to the field of illuminating designated areas, for example pathways, streets, and any other area.

2. Description of the Related Art

The use of lamps dates back centuries. Today, however, many conventional lighting arrangements involve the use of incandescent lighting.

### SUMMARY

The disclosed systems and methods can be defined by numerous embodiments.

One embodiment of the present invention is an illumination device comprising a plurality of LEDs which are disposed on a non-planar support. In another embodiment the non-planar member is able to be retrofit into an existing conventional hood design. In yet another embodiment, the LED non-planar member is receivable into retrofit structures such that the member is able to be replaced if one or more of the LEDs included on it are malfunctioning.

### BRIEF DESCRIPTION OF THE SEVERAL VIEWS OF THE DRAWINGS

Illustrative embodiments of the present invention are described in detail below with reference to the attached drawing figures, which are incorporated by reference herein and wherein:

FIG. 1 is a prospective view of a conventional street light design;

FIG. 2 is a prospective view of the street light design of the disclosed embodiment; and

FIG. 3 is a view of the internal LED components of the disclosed embodiment.

### DETAILED DESCRIPTION

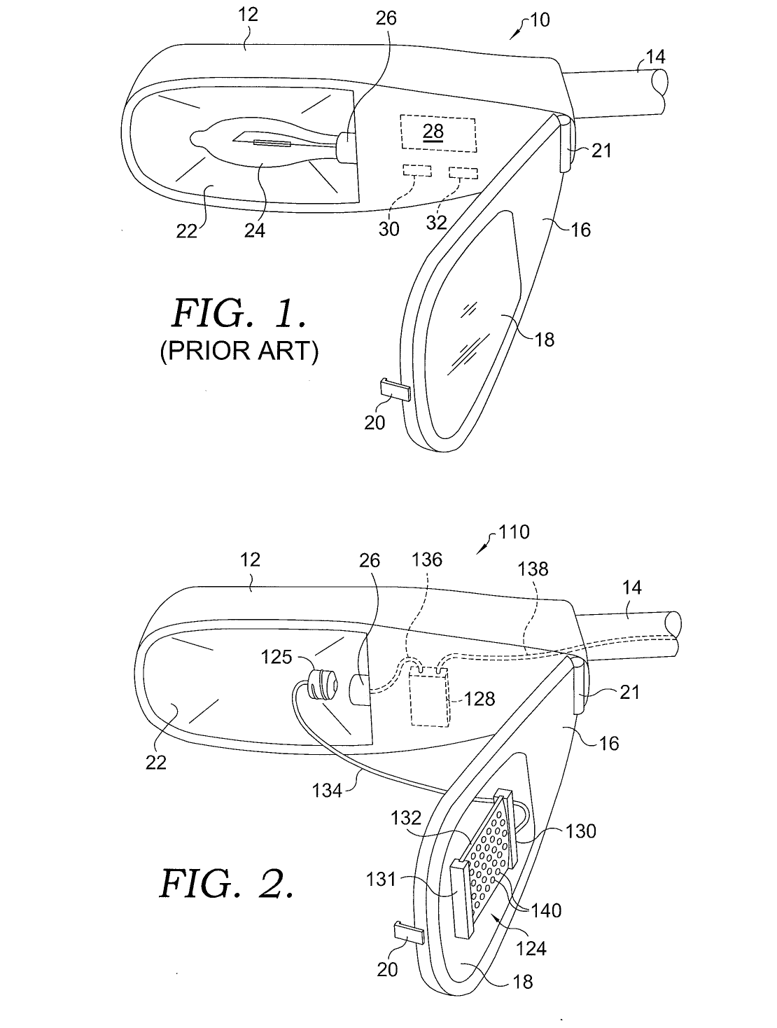

One example of a conventional street light arrangement is shown in FIG. 1. Referring to the figure, one can see that the street light 10 is suspended above the ground on a pole (not shown). The system comprises a hood/housing portion 12 which is directly connected to a horizontal portion 14 of the pole. A lid 16 is used to contain the lamp from beneath. Lid 16 includes a transparent lens 18, which in many embodiments, is substantially flat as shown in FIG. 1. Also part of the lid 16 arrangement, is a latch 20 and a hinge 21 system which enables the lid to be opened, flipped up, and secured. These types of arrangements also normally include a reflector 22 which is used to ideally direct light admitted from a incandescent bulb 24. Bulb 24 can be any number of incandescent lights, but in many situations it is a mercury vapor discharge lamp or some other sort of high-intensity discharge lamp. Lamp bulb 24 is screwed into a socket 26 which is secured within the lamp hood/housing 12. Also within lamp/hood housing 12 is a transformer 28. These arrangements also include a starter 30 and an igniter/capacitor 32 as is known to those skilled in the art.

Many streetlamps—including FIG. 1 kinds of arrangements—exist on today's streets and in other areas in which illumination is desired. As can be observed in any urban center, the number of lights used to illuminate a municipal or other area is very large. Because of this, any slight change in energy consumption by each individual street light will have a multiple effect making it very significant in terms of overall usage. On a lamp by lamp basis, the total power consumed can be very great. The average lamp has a power consumption of 150 Watts. Considering that the average lamp is active for about 4000 hours per year, the cost of operating just one lamp per year—assuming a cost per kW-hr of around 7 cents—would be about $600 dollars per year. Considering further that a city having a population of 500,000 would typically have about 90,000 streetlights, the overall energy-consumption budget for streetlights alone would be around $54 million. Thus, any small reduction in energy consumption by proportion—even slight—would result in tremendous cost savings for the municipality.

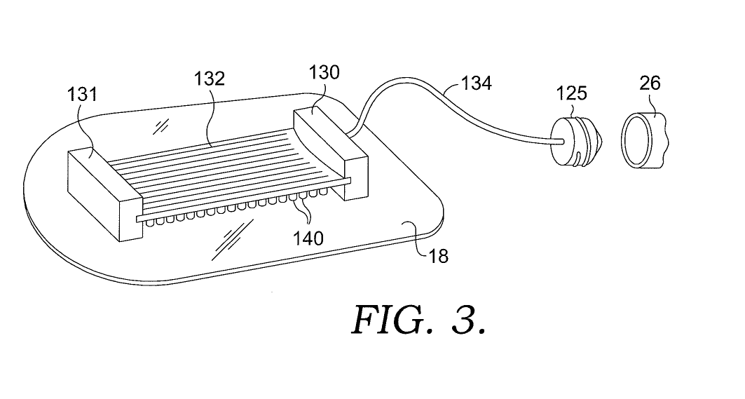

A disclosed embodiment is shown in FIGS. 2 and 3. Referring first to FIG. 2, it can be seen that the retrofit application disclosed is usable within the conventional, already existing arrangement illustrated in FIG. 1. The retrofit application works with the existing hood 12, pole 14, and lid 16 arrangement. The reflector 22 can also be left in place, even though with this application it will not be necessary for light direction purposes.

Where FIG. 2 shows a retrofit arrangement 110 incorporated within the existing lamp structures, FIG. 3 discloses the added components in more detail. The retrofit arrangement includes an LED array assembly 124. In the disclosed embodiment, the LED array is disposed on a nonplanar printed circuit board 132. In one embodiment, board 132 is adapted to have an arcuate cross section. Although the disclosed embodiment board is arcuate, it is also possible that other shapes could be employed to create different lighting patterns. Each end of board 132 in the disclosed embodiment is made to be slidable into one of two reciprocating slots defined within end-receiving units 130 and 131, which in the disclosed embodiment are block-shaped. They could instead be of some other shape or configuration however still including the board receiving slots. For example, for lenses which are not planar, one can easily understand that the end units 130 and 131 would have to have lower surfaces which were able to be adhered to the irregular surface, rather than having substantially flat bottom surfaces. It is also possible that other alternative arrangements could be used to releasably secure the board other than the slotted end units. For example, some sort of clamping, or fastening arrangement could be used instead that is able to enable removably receiving the board.

In the disclosed embodiment where each of the receiving slots are curved upward to match up with the arcuate ends of non-planar member 132, member 132 is able to be removably slid in and out of the blocks. This removability enables the user to easily replace the board when one of the LEDs in the array malfunctions and the light source must be replaced. This will occur much less often than with the conventional designs because LEDs have been shown to last up to ten times as long. But when it does occur, the only thing that needs to be replaced is the board.

As is known in the art, individual LEDs such as those included in plurality of LEDs 140 distribute light in a conical fashion. Thus, unlike the conventional incandescent bulbs (e.g., bulb 24 in FIG. 1) which have a point light sources that are then reflected to direct the light into the desired pattern, LEDs will have a plurality of conical light distributions. Because the non-planar member 132, in the disclosed embodiment, is made arcuate, the light pattern of these cones are adequately laterally dispersed along the roadway, or in any other desired manner. The curved/arched nature of the board 132 helps give the light the lateral spread that is necessary and similar to that provided by the conventional reflected light patterns emitted by prior art designs.

It should be noted, that member 132, although shown as one integral piece in the FIG. 1 and FIG. 2 illustrations, could alternatively be provided in separate longitudinal sections, each having ends which could be received in the channels provided in the end blocks. For example, were member 132 to be broken into for equally sized pieces, each having the same length as member 132, each being one fourth the width, and each having the same curvature, the separate pieces could be individually replaced. Thus, other embodiments are possible which would include four, or any other number of removable LED boards which could each be individually installed or replaced. Further, the boards could all have the same width, or have different widths.

In terms of electrical support for the LEDs 140, first end member 130 is electrically connected via a two part positive/negative conduit 134. Conduit 134 is electrically connected into the existing socket 26 using an Edison attachment 125. This enables the device to be simply screwed into the existing structures.

Work must also be done inside the hood, however, in order to electrically support the LEDs used. This is done by installing a power supply device 128 to replace the conventional devices 28, 30, and 32 (see FIG. 1). One example of a power supply useable as power supply box 128 is Model No. HWS15-5/A manufactured by Lambda Company located in San Diego, Calif. Other acceptable devices, however, could be used as well. Block 128 can be adhered or fixed by known means to the inside of the hood 12. An input port of power supply 128 is electrically connected with the AC power source cord 138. AC power source cord 138 is already included in the conventional structures. Once power source cord 138 is live, box 128 will be used to convert AC source power into DC power which is useable by LEDs. Once converted, the DC power output port from box 128 is then electrically connected into Edison receptacle 26 using a conduit 136. Conduit 136 will be already existing in most conventional streetlight structures, and thus, is simply detached from the conventional equipment 28, 30, and 32, and then reconnected to the DC output side of box 128 such that receptacle 26 will be receive a source of DC power when the AC source is available.

Either before or after the electrical connections have been made inside the hood/housing 12 such that socket 26 is able to deliver power, the nonplanar panel 132 must be electrically connected so that the plurality of LEDs 140 will receive power. Although not shown in the figures, one skilled in the art will know that it is possible to electrically connect the edges of board 132 inside end units 130 and 131 such that the necessary electrical potential can be delivered across board 132. Cord 134 is a standard two-part electrical cord. One part of the wire (positive or negative) is electrically connected to one side of board 132 through end unit 130. The other part of the wire carrying the opposite charge is electrically connected to the other side of the board either through end unit 131, or by other means. In one embodiment, a plurality of individual LED strings are connected in series along the length of the board, and then each sting is connected in parallel to the one beside it. In other embodiments, however, other electrical board connections are possible. For example, in the embodiment disclosed in FIGS. 2 and 3, each of the series connected LED strings are connected in parallel through signal tracing or soldering such that when board 132 is inserted into the slots in end units 130 and 131, all of the LEDs 140 will illuminate once power is administered. This can be done by providing a common electrical conduit on each end of LED member/board 132 which electrically connects all of the LED strips on member/board 132 in parallel. One skilled in the art will recognize that there are numerous different ways to make the electrical connections necessary, and it should be understood that the arrangement described above are only embodiments. Through different board trace arrangements a vast variety of parallel and series arrangements are possible.

In terms of installing the end units 130 and 131 on top of the lens 18 (oftentimes constructed of LEXAN™) of the conventional assembly, the user will first flip down lid 16 to expose the bulb. Next, the user will remove bulb 24 leaving socket 26 exposed. After that, the user will adhere or otherwise attach end units 130 and 131 in the desired locations onto the inside surface of transparent lens 18 as shown in FIG. 2. In terms of proper orientation, it is meant that the end members 130 and 131 should be configured substantially cross wise to the hood. Further, they should be positioned such that when LED board 132 is installed in them the light projected by LEDs 140, because they are disposed on an arched printed circuit board, will create a desired spread pattern for that particular light. The pattern produced will resemble the pattern created by reflector 22 when a conventional bulb is used, but will have more uniform intensity.

Once end units 130 and 131 have been adhered to the upper (inside) surface of the lens, the board is ready to be electrically connected to the DC power source by screwing Edison member 125 into socket 26. This will complete the electrical connection.

Now a user is able to simply slide in the curved LED board 132 and the electrical connection is complete. Once powered up, lamp 110 will require about one tenth of the amount of power normally required of mercury vapor lamps and other conventional arrangements.

And whenever an LED loses functionality, member 132 can be replaced by sliding out the old, and sliding in the new fully functional board. Or, with the embodiment where member 132 is broken into sections, and thus, includes multiple electrically connected boards, the single defective board can be removed, and a substitute section inserted in its place. This preserves the other remaining boards for further use.

Many different arrangements of the various components depicted, as well as components not shown, are possible without departing from the spirit and scope of the present invention. Embodiments of the present invention have been described with the intent to be illustrative rather than restrictive. Alternative embodiments will become apparent to those skilled in the art that do not depart from its scope. A skilled artisan may develop alternative means of implementing the aforementioned improvements without departing from the scope of the present invention.

It will be understood that certain features and subcombinations are of utility and may be employed without reference to other features and subcombinations and are contemplated within the scope of the claims. Not all steps listed in the various figures need be carried out in the specific order described.

The invention claimed is:

1. An illumination system for use in mounting into an existing lighting structure, such structure including a lens, said system comprising:
a plurality of LEDs mounted on a member;
an arrangement for mounting said member in a manner in which said plurality of LEDs direct light through said lens to create a desired pattern.

2. The system of claim 1, wherein said member is nonplanar.

3. The system of claim 1, wherein said mounting arrangement includes two end units each of which is used to secure one end of said member.

4. The system of claim 3, wherein each of said end units includes a curved inside slot, each of said slots receiving one of said ends of said member.

5. An illumination device comprising:
a plurality of LEDs disposed on a member having first and second ends and a curved cross section;
a first mounting device adapted to removably receive said first end of said member;
a second, opposing, mounting device adapted to removably receive said second end of said member;
said first and second opposing devices being mountable atop an existing lens;
a power supply coupler device electrically connected with said LEDs on said member for the purpose of powering said member when said coupler is engaged.
